(19) United States
(12) Patent Application Publication
(10) Pub. No.: US 2021/0163053 A1
(43) Pub. Date: Jun. 3, 2021

(54) MOVABLE LIFTING DEVICE

(71) Applicants: Mettler Toledo Measurement Technology Company Limited, Changzhou (CN); Mettler Toledo (Changzhou) Precision Instrument Ltd., Changzhou (CN); Metter-Toledo International Trading (Shanghai) Co., Ltd., Shanghai (CN)

(72) Inventors: Yinxiu Zhang, Changzhou (CN); Huaqiang Hui, Changzhou (CN); Qingsong Zhao, Changzhou (CN)

(21) Appl. No.: 17/267,860

(22) PCT Filed: Aug. 8, 2019
(86) PCT No.: PCT/CN2019/099782

§ 371 Date: Feb. 11, 2021

(30) Foreign Application Priority Data
Aug. 13, 2018 (CN) 201821298556.3

(51) Int. Cl. B62B 5/00; B60B 33/00; B60B 33/04

(52) U.S. Cl. CPC B62B 5/0086; B62B 5/0089; B60B 33/0015; B60B 33/0039; B60B 33/0049; B60B 33/0063; G01G 23/00; B60B 2200/00; B60B 2900/531; B60B 2900/112; B60B 2900/351; B62B 2202/10; B62B 2301/05; B60B 33/04

(57) ABSTRACT

A movable lifting device has a lifting and fixing device (10) and a moving device (20). One end of the lifting and fixing device is connected to the moving device, and the other end thereof is connected to a cargo to be shifted (30). The free rotation of the lifting and fixing device converts rotary motion into linear motion for lifting the cargo to-be-shifted. The movable lifting device has a simple and flexible structure, is easy to operate, and combines the functions of shifting and lifting. It can be operated anytime and anywhere, and is suitable for a wide range of applications. The movable lifting device reduces labor intensity, saves manpower and material resources, is cheaper to build, and easy to operate.

### TECHNICAL FIELD

The present invention relates to the field of handling small cargo in commercial and industrial settings, and in particular to a movable-type lifting device suitable for lifting and shifting floor scales.

### BACKGROUND ART

Currently, manpower is employed for handling small cargo (100-500 Kg) because such cargo is usually unwieldy.

In general, it is desirable to use loading and transportation means, i.e., a forklift truck, or dedicated equipment such as a hoister for handling cargo. However, it is untenable to have dedicated loading and transportation equipment for small cargo. Such cargo handling equipment occupy valuable commercial and industrial space, thus driving up the overall cost of handling cargo.

Due to the absence of a reliable and cost efficient solution, small cargo is still generally handled by manpower or by means of dedicated equipment such as a forklift and/or a traveling crane. For this reason, small cargo handling operations continue to remain labour intensive. Even setting up dedicated equipment is time consuming due to difficulties in shifting, site specific constraints, costly repair and maintenance, and higher capital expenditure involved in owning said equipment.

In view of these shortcomings associated with prior art solutions, there is a need to develop a movable—type lifting device that can be employed for shifting floor scales in industrial and commercial settings.

### SUMMARY OF INVENTION

The problem to be solved by the present invention is the absence of a simple and efficient solution for lifting and shifting of small cargo. The present invention overcomes the defects associated with prior art solutions available for loading and transporting small cargo.

The above-mentioned technical problem is solved by the present invention, in which there is provided: a movable-type lifting device, comprising a lifting and fixing device and a moving device, wherein one end of the lifting and fixing device is connected to the moving device and the other end thereof is connected to a cargo to-be-shifted; the lifting and fixing device further comprises a rotary screw, a lifting and fixing bracket; wherein the lifting and fixing bracket comprises a threaded sleeve and a bracket body, the bracket body extending outward and obliquely downward along an outer wall face of the threaded sleeve, and the rotary screw being mounted to the threaded sleeve; and the free rotation of the rotary screw converts rotary motion into a linear motion for lifting the cargo to-be-shifted.

According to an embodiment of the present invention, one end of the lifting and fixing bracket is connected to the cargo to-be-shifted by means of the fixed connection bolt. The rotary screw is in threaded connection with the other end of the lifting and fixing bracket.

According to an embodiment of the present invention, the rotary screw is mounted to the threaded sleeve to form a rotary motion to drive a bearing of the moving device to rotate.

According to one embodiment of the present invention, the moving device is a universal wheel.

According to one embodiment of the present invention, the lifting and fixing bracket is further provided with reinforcing ribs, and the reinforcing ribs are disposed on two sides of the bracket body.

According to one embodiment of the present invention, the reinforcing ribs surround the threaded sleeve and an outer side wall of the bracket body.

According to one embodiment of the present invention, a lower end of the bracket body is provided with a mounting table, and the mounting table is connected to the cargo to-be-shifted by means of the fixed connection bolt.

According to one embodiment of the present invention, two sides of the mounting table are provided with side plates, and the side plates are connected between the lower end of the bracket body and the mounting table.

According to one embodiment of the present invention, the cargo to-be-shifted is a floor scale.

The present invention has the following positive progressive effects: the movable-type lifting device of the present invention has a simple and flexible structure; it is easy to operate, and combines the functions of shifting and lifting; it is versatile and it can be adapted to wide range of applications. The inventive solution can significantly reduce the labour intensity and save valuable manpower, material resources, and costs, and it is easy to adopt.

### BRIEF DESCRIPTION OF DRAWINGS

The above-mentioned and other features, properties and advantages of the present invention will become more apparent from the following description of the embodiments with reference to the accompanying drawings, where:

FIG. 1 is a structural schematic representation of a movable-type lifting device of the present invention.

FIG. 2 is a representation of a movable-type lifting device of the present invention when in use.

### DESCRIPTION OF EMBODIMENTS

To make the above-mentioned object, features and advantages of the present invention more apparent and easy to understand, a detailed description of a specific embodiment of the present invention is provided in conjunction with the accompanying drawings.

An embodiment of the present invention will be described now in detail with reference to the accompanying drawings. Reference will be made now in detail to a preferred embodiment of the present invention, examples of which are illustrated in the accompanying drawings. The same reference numerals used in all the figures denote identical or similar parts wherever possible.

Furthermore, although the terms used in the present invention are selected from well-known common terms, some of the terms mentioned in the description of the present invention may have been selected by the applicant according to his or her determination, and the detailed meaning thereof will be illustrated in the relevant section described herein.

Furthermore, the present invention must be understood, not simply by the actual terms used but also by the meaning of each term.

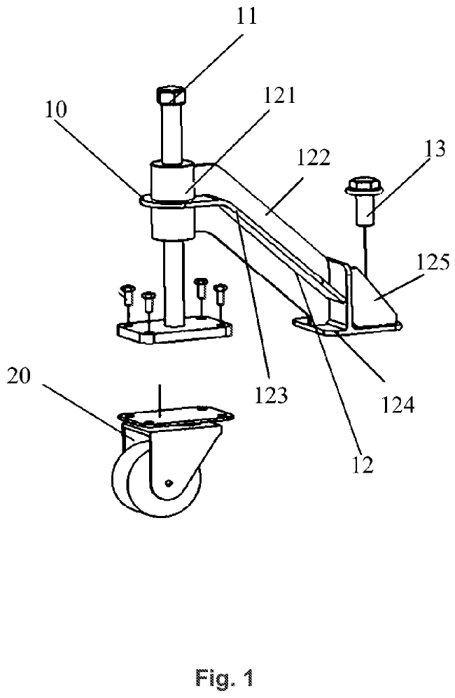

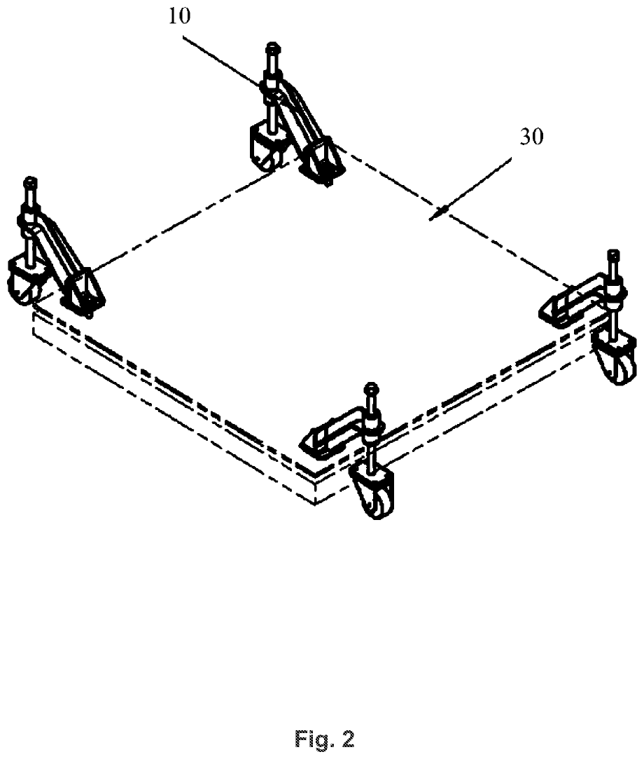

FIG. 1 is a structural schematic representation of a movable-type lifting device of the present invention. FIG. 2 represents a movable-type lifting device of the present invention when in use.

As shown in FIGS. 1 and 2, the present invention discloses a movable-type lifting device, comprising a lifting and fixing device 10 and a moving device 20. One end of the lifting and fixing device 10 is connected to the moving device 20, and the other end thereof is connected to a cargo to-be-shifted 30. The free rotation of the lifting and fixing device 10 converts rotary motion into linear motion so as to displace the cargo to-be-shifted 30. The cargo to-be-shifted 30 herein is preferably a floor scale.

Preferably, the lifting and fixing device 10 comprises a rotary screw 11, a lifting and fixing bracket 12 and a fixed connection bolt 13. One end of the lifting and fixing bracket 12 is connected to the cargo to-be-shifted 30 by means of the fixed connection bolt 13, and the rotary screw 11 is in threaded connection with the other end of the lifting and fixing bracket 12. Further, the lifting and fixing bracket 12 comprises a threaded sleeve 121 and a bracket body 122. The bracket body 122 extends outward and obliquely downward along an outer wall face of the threaded sleeve 121, and the rotary screw 11 is mounted to the threaded sleeve 121 to create a rotary motion that drives a bearing of the moving device 20 to rotate. The moving device 20 herein is preferably a universal wheel.

In addition, the lifting and fixing bracket 12 is further provided with reinforcing ribs 123, and the reinforcing ribs 123 are disposed on two sides of the bracket body 122. The reinforcing ribs 123 surround the threaded sleeve 121 and an outer side wall of the bracket body 122. A lower end of the bracket body 122 is provided with a mounting table 124, and the mounting table 124 is connected to the cargo to-be-shifted 30 by means of the fixed connection bolt 13.

Further, two sides of the mounting table 124 are provided with side plates 125, and the side plates 125 are connected between the lower end of the bracket body 122 and the mounting table 124.

According to the above structural description, the movable-type lifting device of the present invention utilizes a lifting and fixing device 10 and a moving device 20, with a bolted coupling being used therebetween. The lifting and fixing device 10 comprises a rotary screw 11, a lifting and fixing bracket 12 and a fixed connection bolt 13. The fixing bracket 12 and an cargo to-be-shifted are fixed by a detachable fixed connection bolt 13, so that the lifting and fixing bracket 12 and the cargo to-be-shifted form a unitary whole. The rotary screw 11 interacts with the threads of the threaded sleeve 121 and drives the bearing of the shifting device 20 to rotate, thereby converting the rotary motion of the rotary screw 11 into a linear motion so as to lift the cargo to-be-shifted 30.

With the movable-type lifting device of the present invention, the lifting and fixing device 10 and the floor scale are envisaged as a unitary whole. By way of rotating the fixed connection bolt 13, a rotary motion between the rotating fixed connection bolt 13 and the lifting and fixing bracket 12 is converted into linear motion that induces the floor scale to rise. The lifting and fixing bracket 12 is connected to the shifting device 20, so that after the floor scale rises above the ground, the floor scale can be easily shifted. Based on the weighing capacity, i.e., the size, of the floor scale, the required number, generally 2 sets or 4 sets, of movable-type lifting devices can be employed.

In summary, the movable-type lifting device of the present invention is capable of performing the functions of lifting and shifting without the need for equipment such as forklift, a traveling crane and the like. It has a simple and small structure, and can perform lifting and shifting anytime and anywhere when used, effectively reducing the labor intensity for handling, thus saving valuable manpower, material resources and costs.

While a particular embodiment of the present invention is described above, a person skilled in the art should understand that these are merely illustrative and that the scope of protection of the present invention is defined by the appended claims. Various alterations or modifications can be made by a person skilled in the art to these embodiments without departing from the principle and substance of the present invention. However, these alterations and modifications all fall within the scope of protection of the present invention.

### REFERENCE SIGNS LIST

lifting and fixing device 10

moving device 20

cargo to be shifted 30

rotary screw 11

lifting and fixing bracket 12

fixed connection bolt 13

threaded sleeve 121

bracket body 122

reinforcing rib 123

mounting table 124

side plate 125

1. A movable device for lifting a cargo to-be-shifted, comprising:
a lifting and fixing device, having a first end and a second end; and
a moving device, the first end of the lifting and fixing device is connected to the moving device, and the second end is connected to the cargo to-be-shifted;
wherein the lifting and fixing device further comprises:
a rotary screw; and
a lifting and fixing bracket that comprises a threaded sleeve and a bracket body which extends outward and obliquely downward along an outer wall face of the threaded sleeve with the rotary screw mounted to the threaded sleeve, such that free rotation of the rotary screw converts rotary motion into a linear motion for lifting the cargo to-be-shifted.

2. The movable device of claim 1, wherein the moving device is a universal wheel.

3. The movable device of claim 2, further comprising:
reinforcing ribs of the lifting and fixing bracket that are disposed on two sides of the bracket body.

4. The movable device of claim 3, wherein the reinforcing ribs surround the threaded sleeve and an outer side wall of the bracket body.

5. The movable device of claim 1, further comprising:
a mounting table at a lower end of the bracket body; and
a fixed connection bolt that connects the mounting table to the cargo to-be-shifted.

6. The movable device of claim 5, further comprising:
side plates on two sides of the mounting table, the side plates being connected between the lower end of the bracket body and the mounting table.

7. The movable device of claim 1, wherein the cargo to-be-shifted is a floor scale.

8. The movable device of claim 1, further comprising:
reinforcing ribs of the lifting and fixing bracket that are disposed on two sides of the bracket body.

9. The movable device of claim 8, wherein the reinforcing ribs surround the threaded sleeve and an outer side wall of the bracket body.

10. The movable device of claim 4, further comprising:
a mounting table at a lower end of the bracket body; and
a fixed connection bolt that connects the mounting table to the cargo to-be-shifted.

11. The movable device of claim 10, further comprising:
side plates on two sides of the mounting table, the side plates being connected between the lower end of the bracket body and the mounting table.
